(19) United States
(12) Patent Application Publication
(10) Pub. No.: US 2008/0140561 A1
(43) Pub. Date: Jun. 12, 2008

(54) Debit card method of making loan proceeds available quickly to a borrower

(76) Inventor: Gerald A. Neel, Anaheim, CA (US)

Correspondence Address: GERALD A. NEEL, 2055 S. JUNE PLACE, ANAHEIM, CA, 92802, US

(21) Appl. No.: 11/636,296

(22) Filed: Dec. 8, 2006

(51) Int. Cl. G06Q 40/00

(52) U.S. Cl. 705/38; 705/41

(57) ABSTRACT

Immediate use of a borrower's loan proceeds is obtained by establishing a bank account in a lending institution, the account dedicated exclusively to a debit card program, executing a monetary lending proceeding resulting in availability of the loan proceeds to the borrower, issuing a first financial instrument representing a first portion of the loan proceeds, wherein use of funds represented by the first financial instrument is delayed over a time period of at least 72 hours; and issuing a second financial instrument representing a second portion of the loan proceeds, wherein use of funds represented by the second financial instrument is delayed over a time period of not more than three hours.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### REFERENCE TO A “MICROFICHE APPENDIX”

Not applicable.

### BACKGROUND OF THE INVENTION

1. Field of the Present Disclosure

This disclosure relates generally to specialty financial instruments such as credit cards and gift cards having specific purposes, methods of use, applications or restrictions, and more particularly to a credit card financial instrument and a method creation, approval and use for hastening the availability of at least a portion of funds to a recipient of a qualified proceeds.

2. Description of Related Art Including Information Disclosed Under 37 CFR 1.97 and 1.98

Hogan et al., US 20060265335, discloses a system and method for direct loading of prepaid debit cards at point of sales (POS) devices via an Internet channel. A centralized on demand model is provided so that any merchant operating a POS device can issue a prepaid debit card to a customer.

Pallares, US 20060138215, discloses a system for operating a prepaid reloadable debit card. The system includes providing ancillary services associated with the prepaid reloadable debit card. The prepaid reloadable debit card is primarily directed to the “unbanked” population and may provide a means for remittance to immigrants for transferring funds to family members back home using existing ATM and credit card infrastructures.

Willard, US 20030212796 discloses how to allow a customer to load money in real-time through existing technology over the existing ATM/debit network by way of a debit return with a PIN (or debit correction/reversal using a specific transaction code). Money may then be loaded in real-time on an anonymous stored value/debit/ATM/multi-purpose/private transaction PIN-based card. Loading of money on a card or cards with or without the same account numbers is also provided for.

Dawson, US 20030057274 discloses a secured debit card package having an embedded value and being adapted to be sold from open and unprotected retail shelving. The secured debit card package comprises a debit card, formed as from a first material bearing a card identification number, and packaging means formed as from a second different material securing the debit card thereto, the packaging means defining a window through which the card identification number is visible, a magnetic stripe disposed on the packaging means, the magnetic stripe bearing an encoded representation of a card identification number borne by the debit card, the stripe being positioned to be scanned by a terminal for reading the encoded representation from the packaging means and for transmitting the encoded representation to a remote processing center for testing of the representation to determine whether the debit card should be activated. A method for providing security for the embedded value of a debit card is also disclosed.

Mon, US 20020055904 discloses an apparatus and method for processing loans including receiving a loan application from a remote location, including a payday loan machine, processing the loan and depositing finds to the debtor's account or dispensing the loans directly to the client.

The related art described above discloses methods for issuing pre-loaded debit cards to customers at point of purchase, re-loadable debit cards and methods therefore, self-loadable debit cards and methods therefore, methods for securing pre-loaded debit cards available outside the banking system, and a method for processing loans through a machine with immediate payout to the borrower. However, the prior art fails to disclose a system and method for providing immediate payout of mortgage loan proceeds and similar situations through the use of a debit card and account generating procedure. The present disclosure distinguishes over the prior art providing heretofore unknown advantages as described in the following summary.

### BRIEF SUMMARY OF THE INVENTION

This disclosure teaches certain benefits in construction and use which give rise to the objectives described below.

Mortgage Companies and other lending institutions (lenders) all have a well documented and specific procedure for making loans. Such procedures include accurately identifying and recording information related to qualifying a borrower in order to approve a new loan. Once approved a borrower is interested in receiving the proceeds of the loan as soon as possible. Since delays normally occur between the time that the loan is approved and the moment when the borrower is able to actually use the proceeds, there is a need for an improved method for shortening or eliminating such delays. A typical wait time between the issuance of a proceeds check by an escrow company and the availability of such funds is currently approximately six working days.

The present invention defines a method that follows an automatic funds issuance protocol. In this method, a debit card is issued to a borrower when a selected point of the lending proceeding has been reached. Once this has occurred the debit card is mailed to the borrower's home address, and subsequently, when the loan closes, funds are electronically transferred from the escrow company into an account held by a participating debit card company, thereby making the funds available to the borrower within hours of the closing, instead of days.

Mortgage Companies and other lending institutions seek to encourage repeat customers encouraging word of mouth referrals. Expediting the disbursement of funds is greatly satisfying to the borrower and will spur referral actions. Another aspect of the present invention is that the debit card has logo and other trade dress indicia printed on its face, as well as a toll free telephone number associated with the lender. As the borrower uses this debit card, such indicia is a strong reminder of where the loan was obtained and the benefits of doing business including how fast the proceeds were made available. This fact increases the probability of one borrower referring the lender to another potential borrower.

A primary objective inherent in the above described apparatus and method of use is to provide advantages not taught by the prior art.

It is one of the main objects of the present invention to provide a system and method for making funds available immediately to a borrower by administering debit cards that require a minimum of paperwork, maintenance and financial disclosure from the card holder.

Another object of the invention is to overcome the wait time and other drawbacks in existing lending procedures.

A further object of the invention method is to provide activation of a debit card by the borrower.

A further object of the invention method is to provide for the issuer to determine a monetary amount backing a debit card.

A further object of the invention method is to enable the borrower to increase the monetary amount backing the debit card.

A further object of the invention method is to enable card activation when the issuer learns that the borrower has received the debit card.

A further object of the invention method is to provide for the issuer of a debit card to notify a title and escrow company that the borrower has received the debit card.

A further object of the invention method is to provide a limited activation time period for a debit card.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing is a best mode embodiment of the present invention In such drawing:

FIG. 1 is a diagram illustrating the method of the present invention.

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation in the scope of the present apparatus and method of use.

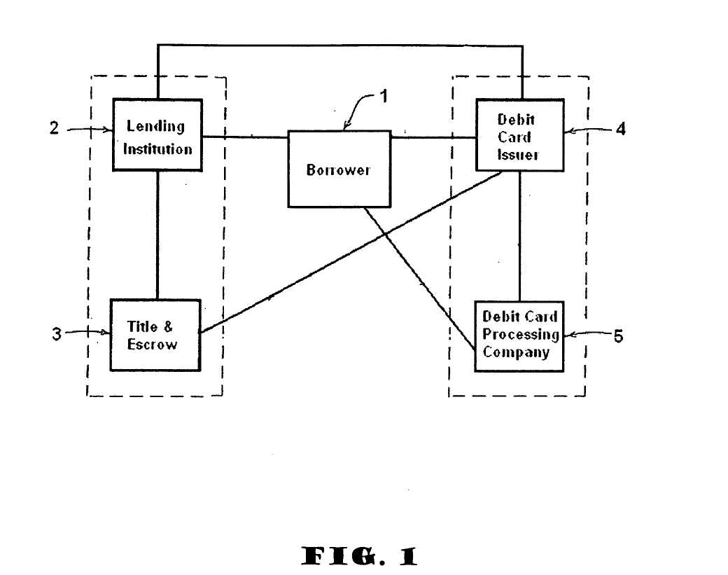

Referring now to FIG. 1, described now in detail is the system and method of the present invention. The method begins with a borrower 1 initiating a new loan with a lending institution 2 (lender) by submitting a loan application. The loan application paperwork is preferably accompanied by an optional cardholder application for a new debit card to be later cleared for use against a new debit card bank account containing all, or a portion, of the loan's proceeds, should the loan be approved. If the borrower 1 elects to use the debit card, and the loan is approved, the proceeds are made available to the borrower 1 without undue delay upon close of the loan.

Upon receipt of the loan application, the lender 2 opens an escrow account with a title and escrow company 3 and also sends the completed cardholder application to a debit card issuing company 4.

The issuing company 4 creates an account for a new debit card with a debit card processing company 5.

The processing company 5 establishes and manages the debit card account. Establishing the debit card requires creation of a debit card account including recording the borrowers name, address and phone number; imprinting a new physical card with a unique account number, user name and expiration date; and encoding the card to record the debit amount that may be drawn by the borrower.

Next, the processing company 5 forwards the card to the issuing company 4, and the issuing company 4 mails the card to the borrower's home address. The borrower is now in possession of the card, but the associated debit account has riot yet been funded.

When the loan closes, the cash-out proceeds due to the borrower 1 are electronically transferred from the escrow company 3 to the issuing company 4.

The borrower 1, being notified by the lender that the loan has closed, calls the debit card processing company 5 to activate the card. The issuing company 4 identifies the borrower by name, address, social security number, or other unique identifiers.

The borrower 1 may now use the card to make purchases against the balance in the card's supporting bank account for any purchase whatsoever without restriction. Each time a purchase is made using the card, the amount of the purchase reduces the account balance. The card remains active as long as a positive balance remains in its account.

In one embodiment of the present method, when the balance has been depleted, the card expires. In a second embodiment, deposits may be made to the card's account by the borrower, or others, and the card will remain active until the borrower requests termination. In a third embodiment the card is active for a set period of time and then expires, whereby any balance is forwarded to the borrower by check.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A method of providing immediate use of a loan proceeds to a borrower comprising the steps, essentially in sequence, of:
a) initiating a monetary lending proceeding with a lender;
b) establishing a bank account, the bank account dedicated exclusively to a debit card program, and providing a corresponding debit card to the borrower;
c) issuing, to the borrower, a financial instrument representing a first portion of the loan proceeds, wherein availability for trading of the first portion of the loan proceeds is delayed until the financial instrument is cleared; and, at the same time, funding the bank account with a second portion of the loan proceeds, wherein the debit card is enabled for immediate trading.

2. The method of claim 1 wherein the first financial instrument is a check.

3. The method of claim 2 further comprising the step of printing a name and telephone number of the lender on the debit card.

4. A method of providing immediate use of a loan proceeds to a borrower comprising the steps, in sequence, of:
a) initiating a monetary lending proceeding with a lender, and at essentially the same time, establishing a bank account, the bank account dedicated exclusively to a debit card program for receiving proceeds of the monetary lending proceeding, and thereafter, providing a corresponding debit card to the borrower; and
b) issuing, to the borrower, a loan proceeds from the monetary lending proceeding by finding the bank account, wherein the debit card is enabled for immediate trading.

5. The method of claim 4 further comprising the step of printing a name and telephone number of the lender on the debit card.

6. A method of providing, to a borrower, use of at least a portion of a loan proceeds at the time of closing of a loan, the method comprising the steps of:
a) submitting a loan application to a lender;
b) submitting a debit card application form to a bank;
c) opening an escrow account with an escrow facilitator;
d) establishing a debit card account;
e) mailing a debit card, corresponding to the debit card account, to a home address of the borrower;
f) approving and closing the loan making the loan proceeds available for pay-out to the borrower;
g) transferring at least a portion of the proceeds electronically to the debit card account and thereby placing said proceeds portion in the debit card account for immediate use; and
h) notifying the borrower that the loan has closed;
i) activating the debit card for immediate use for purchases by the borrower.

7. The method of claim 6 further comprising the step of closing the debit card account upon depletion of a balance therein.

8. The method of claim 6 further comprising the step of closing the debit card account upon termination of a preset period of time.

9. The method of claim 6 further comprising the step of maintaining a balance in the debit card account by the borrower.

10. The method of claim 6 further comprising the step of determining the debit card funding amount from the proceeds of the loan.

11. The method of claim 6 further comprising the step of providing the borrower with conditions for the validation and availability of the loan proceeds.
(caller id identifies that the caller is calling from the same phone as appears on the loan application)

12. The method of claim 6 further comprising the step of issuing a personal identification number (PIN) to the borrower and requiring the PIN for activation of the debit card.
(PIN is selected by borrower upon completion of the card holder application form.)

13. The method of claim 6 further comprising the step of assigning to the debit card a card number beginning with a unique International Standards Organization identification number assigned for the given debit card to which transactions are routed for processing.

14. The method of claim 6 further comprising the step of branding the debit card with a logo and trade dress associated with the issuing lender.
